(19) United States
(12) Patent Application Publication
(10) Pub. No.: US 2007/0011706 A1
(43) Pub. Date: Jan. 11, 2007

(54) Video browsing system and method

(75) Inventors: Chaucer Chiu, Taipei (TW); Li-Jun Chen, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/289,227

(22) Filed: Nov. 28, 2005

(30) Foreign Application Priority Data
Jul. 11, 2005 (TW) 094123329

(51) Int. Cl. H04N 7/16; G06F 9/00; G06F 3/00; G06F 13/00; G06F 17/00; H04N 5/445

(52) U.S. Cl. 725/56; 725/135; 725/37; 715/838

(57) ABSTRACT

A video browsing system and method applied in an electronic device having a display unit for playing video, the system includes a processing unit; an input unit for allowing a user to input a switching instruction and a selecting instruction, and sending the instructions to the processing unit; an intercepting module for intercepting a plurality of channel information when the switching instruction is a multi-picture display instruction; and a storage unit for storing the plurality of the channel information intercepted by the intercepting module to be displayed by the processing unit on the display unit in a multiple-picture display mode, wherein upon receiving the selecting instruction sent from the input unit, the processing unit obtains the channel information corresponding to the picture indicated by the selecting instruction and dynamically plays the information on the display unit.

### BACKGROUND OF THE INVENTION

1. Field of the Invention

The present invention relates generally to channel information browsing processes, and more particularly, to a video browsing system and method for allowing video information to be browsed by a picture switch display manner.

2. Description of the Background Art

With the quick development of the electronic technology, various electronic devices with the function of video browse have been increasingly developed in the industry. Taking the television with common use for example, due to its features of providing variant information and spreading quickly, the user can receive a variety of programs to absorb new knowledge and obtain latest news information, and the entertainments what provided have become one of the manners of relaxing and entertaining for many people, accordingly, television has become essential to people as an import technology product in daily life.

However, with the surging television channel programs, how to quickly and efficiently browse the video programs has become a talk for concern. As far as present browsing manners of the video program are concerned, the user employs the input unit such as key or TV remote controller of the television to select and browse program, however, such manner lacks immediacy and convenience, especially, due to numerous channel programs capable of being received by the television, the browsing velocity of the program is greatly affected, since that only one channel program can be browsed at a time, if all programs are wanted browsing, quite a bit of time and energy will be consumed, and the user's interest will be greatly affected, and the service life will be also relatively reduced, due to the frequent operation of the television or TV remote controller.

Furthermore, the method for displaying as multi-picture manner has been put into service, for example, the Chinese Mainland Patent Application No. 97105338.3 proposes a technique of employing the editor to edit the image of the television channel into picture and displaying picture menu in the form of multiple pictures for selecting. Such program browsing manner indeed greatly enhances the channel select velocity, however, the multiple pictures provided in this embodiment are all static, and the picture selected in the picture menu can not be changed to dynamic picture and played either, the picture is still static, merely when the television channel corresponding to the selected picture is displayed in full screen, the picture can be played dynamically. When browsing the program video by this embodiment, the user often can not clearly learn the program content what the static picture represented from the static picture only, because the picture contents corresponding to various channels are not dynamically played for a specific period of time. If some picture program selected from multi-picture program menu is found that it is not the required program after it is played in full screen, there is nothing to do but switch to the state of multi-picture program menu again and select once again, thus, it is similarly inconvenient for the user to browse and select the programs.

Accordingly, there exists a strong need in the art for a television program browsing system and method to solve the drawback of the above-described conventional technology, so as to conveniently browse the video program for the user.

### SUMMARY OF THE INVENTION

In light of the foregoing problems in the prior art, it is an objective of the present invention to solve the aforementioned problems by providing a video browsing system and method which displays multiple pictures of video programs for browsing and dynamically plays the channel content corresponding to a selected picture, so that the user can more quickly and efficiently select a wanted video program.

It is another objective of the present invention to provide a video browsing system and method which allows the user to quickly and repeatedly perform switching process between a single-picture display mode and a multi-picture display mode, so that the video browsing time is greatly saved, and the operating flow is greatly simplified.

In order to attain the object mentioned above and the others, a video browsing system and method according to the present invention is proposed. The video browsing system applied in an electronic device having a display unit for playing channel information comprises: a processing unit; an input unit electrically connecting with the processing unit for allowing a user to input a switching instruction of a displayed picture and a selecting instruction, and sending the instructions to the processing unit; an intercepting module electrically connecting with the processing unit for intercepting a plurality of channel information when the switching instruction received by the processing unit from the input unit is a multi-picture display instruction; and a storage unit electrically connecting with the processing unit and the intercepting module for storing the plurality of the channel information intercepted by the intercepting module to be displayed by the processing unit on the display unit in a multiple-picture display mode in at least one page, wherein in response to receiving the selecting instruction sent from the input unit, the processing unit obtains the channel information corresponding to the picture indicated by the selecting instruction and dynamically plays the information on the display unit.

Wherein, the switching instruction sent from the input unit further comprises a single-picture display instruction, causing the processing unit to display channel information as a single picture on the display unit upon receiving the single-picture display instruction sent from the input unit.

Furthermore, the processing unit causes the display unit to page by page display the pictures corresponding to the plurality of channels on the corresponding display page according to the plurality of channel information stored in the storage unit, and makes the display unit flip pages according to a page-flipping instruction received by the input unit.

The video browsing method according to the present invention, which is applied in an electronic device having a display unit and an input unit for playing the channel information, comprises steps of: the electronic device intercepting and storing a plurality of channel information upon determining that a switching instruction to a multi-picture display mode is received by the input unit; reading the stored plurality of channel information, and displaying the information on the display unit in the multi-picture display mode in at least one page for browsing; and upon determining that the input unit receives a selecting instruction of a desired channel information, the electronic device obtaining the channel information corresponding to the picture indicated by the selecting instruction and dynamically playing the information.

By virtue of the above-described video browsing system and method, the user can use the multi-picture display mode to quickly browse a plurality of channel information and select a picture therein to immediately play the channel corresponding to the selected picture, so as to fulfill quick browse and efficient selection of video channel programs, and fulfill quick switching between the single-picture display mode and the multi-picture display mode, thereby, the time of channel selection can be saved, and the operating flow can be simplified.

### BRIEF DESCRIPTION OF THE DRAWINGS

FIG. 1 is a block schematic diagram of a basic structure of a video browsing system according to the present invention;

FIG. 2 is a schematic diagram of an embodiment of an input unit in the video browsing system according to the present invention;

FIG. 3 is a schematic diagram of an embodiment of display content of a display unit used in conjunction with the video browsing system of the present invention; and

FIG. 4 is an operational flowchart of a video browsing method according to the present invention.

### DESCRIPTION OF THE PREFERRED EMBODIMENTS

The following description contains specific information pertaining to the implementation of the present invention. One skilled in the art will readily recognize other advantages and features of the present invention after reviewing contents disclosed in the present application. The present invention can be implemented and applied in a manner different from that specifically discussed in the present application. It should also be understood that the invention is not limited to the particular exemplary embodiments described herein, but is capable of many rearrangements, modifications, and substitutions without departing from the spirit of the present invention.

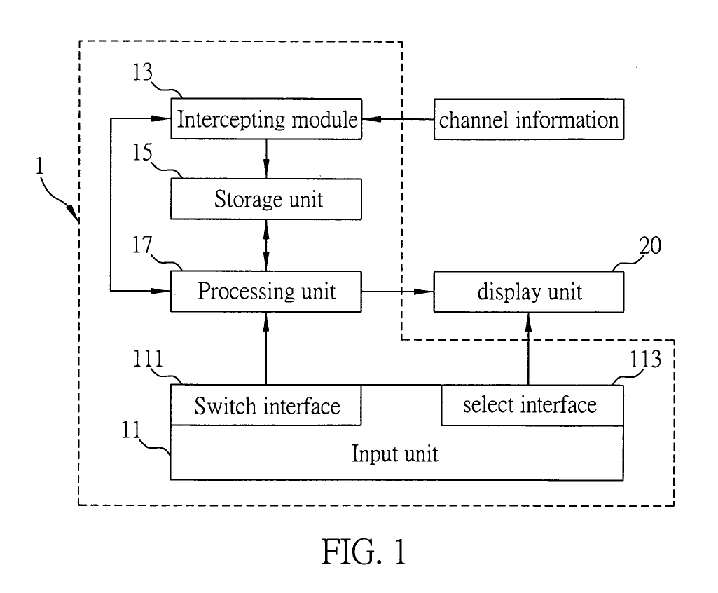

FIG. 1 depicts a block schematic diagram of the system structure according to the video browsing system 1 of the present invention, the video browsing system 1 comprises an input unit 11, an intercepting module 13, a storage unit 15 and a processing unit 17. The video browsing system 1 can be applied in an electronic device (not illustrated) having a display unit 20 for controlling the electronic device to play channel information. The electronic device is, for example a television, a mobile phone, a PDA (Personal Digital Assistant) and a mobile disk player, and the display unit 20 is, for example, a LCD (Liquid Crystal Display), a CRT (Cathode Ray Tube), PDP (Plasma Display Panel) and the like.

The input unit 11 includes a switch interface 111 and a select interface 113. The switch interface 111 is used to switch the manners in which video pictures are displayed between a single-screen (i.e. picture) display and a multi-screen (i.e. picture) display provided by the display unit 20, i.e., the display status can be switched from the single-picture display to the multi-picture display, or from the multi-picture display to the single-picture display, the switch interface 111 can be provided on a TV box (i.e. television key) or a TV remote controller, in this exemplary embodiment, the switch interface 111 is a switch key (switch key 111′ as shown in FIG. 2) provided on the TV remote controller, thereby the switching of the picture display modes can be easily fulfilled by touching the switch key. The select interface 113 can be provided on the TV box or the TV remote controller, in this exemplary embodiment, the select interface 113 is a select key (select key 113′ as shown in FIG. 2) provided on the TV remote controller. Alternatively, if the display unit 20 is touch screen, the select interface 113 can be provided on the display unit 20.

The intercepting module 13 is used to intercept information of multiple channels (generally includes video or audio information), that is, intercept television channel programs for a period of time or at a time point, wherein, the number of the television channel programs and duration can be set according to the practical situation. For example, the multiple channels intercepted can include all channel programs capable of being received by the television or most often being watched by a viewer. The intercepting module 13 can be provided in the TV box or a television channel receiver (not illustrated). When the TV box or the television channel receiver is powered on, or when the user selects the option of browsing channel programs in multi-picture display, or at regular intervals (e.g. one minute or 5 seconds) after the TV box or the television channel receiver is powered on, the intercepting module 13 immediately performs the intercepting process of channel information.

The storage unit 15 is used to store static pictures of the channel information intercepted by the intercepting module 13 at one certain time point, the storage unit 15 is a memory or a register. The static pictures stored in the storage unit 15 are stored according to the static pictures of the programs at one certain time point (e.g. when the user selects the option of browsing channel programs in multi-screen display) intercepted by the intercepting module 13, so the static pictures of programs stored in the storage unit 15 can be changed and updated in time according to the program channel contents actually received by the intercepting module 13. The above-described period or point of time may vary according to the implementation, they are not limited to the aforementioned situation during or at which the intercepting module 13 intercepts static pictures of the channel information, that is, the channel information stored in the storage unit 15 can be updated at a predetermined time point according to the channel information intercepted by the intercepting module 13 based on requirements.

The processing unit 17, for example, a CPU (Central Processing Unit), a MPU (Micro Processing Unit), a controller and the like, is used to read out the channel programs stored in the storage unit 15 and display a portion of the channel information stored in the storage unit 15 according to the number of the pictures in the display unit 20 capable of being displayed set by the user (when all the channel programs stored in the storage unit 15 cannot be displayed on the multi-picture display provided by the display unit 20 at once, it is displayed on the next page, since that the paging process is a conventional function of an ordinary display process, it will not be further described in detail), and the processing unit 17 is also used to dynamically and immediately play the corresponding picture according to the select signal received by the select interface 113 of the input unit 11. When the user sets the display unit 20 to display multiple pictures on a single screen, the multiple pictures displayed on the display unit 20 are static images. Generally, the static image is intercepted from each of the program channels by the intercepting module 13 at certain time point (e.g. when the user selects the browsing function for displaying the channel programs in multi-picture mode), however, when the user selects one picture from multiple pictures displayed on the display unit 20 via the select interface 113, the processing unit 17 immediately makes the intercepting module 13 pick up the channel information of the program channel corresponding to the selected picture, thereby dynamic and immediate playing is fulfilled.

Wherein, after a channel program from the multiple pictures on the display unit 20 selected by the user via the select interface 113 of the input unit 11 and a segment content of the selected channel program is dynamically played, if the content cannot satisfy what the user wanted, the display unit 20 can be controlled by the switch interface 111 of the input unit 11 to stop dynamically playing the channel program, and returned to statically display the multiple pictures, so that the users can select the desired channel program once again.

Furthermore, in another exemplary embodiment, the content stored in the storage unit 15 can also be a segment of the channel program intercepted by the intercepting module 13, thus when the user selects one picture from multiple pictures displayed on the display unit 20 via the select interface 113, the processing unit 17 can immediately reads out the segment of the channel program corresponding to the picture from the storage unit 15, thereby dynamic and immediate playing is fulfilled.

With reference to FIG. 2, an application schematic diagram of the input unit in the video browsing system 1 according to one embodiment of the present invention is shown, the input unit 11 in the exemplary embodiment is, for example, a TV remote controller, as described above, the main feature of the input unit 11 is that a switch interface 111 and a select interface 113 are disposed thereon. The switch interface 111, for example a switch key 111′, is used to switch the channel picture display mode between the single-picture display and the multi-picture display of the display unit 20 via the input unit 11 (i.e. a TV remote controller shown in this exemplary embodiment), the switching of the picture display mode can be easily fulfilled by touching the switch key 111′. The select interface 113 is composed of a set of directional keys 1130 and a confirm key 1132, wherein, the set of directional keys 1130 further comprises an upward key 1130a, a downward key 1130b, a leftward key 1130c and a rightward key 1130d, allowing the user to agilely select among the multiple pictures displayed on the display unit 20. The confirm key 1132 is used to confirm the picture currently chosen, then, with reference to the channel corresponding to the chosen picture, the processing unit 17 can make the intercepting module 13 immediately pick up and dynamically play the content of the channel. Of course, the select interface 113 can also use a set of numeric keys 21 (including 0, 1 to 9 numeric keys) to browse and select the channel picture.

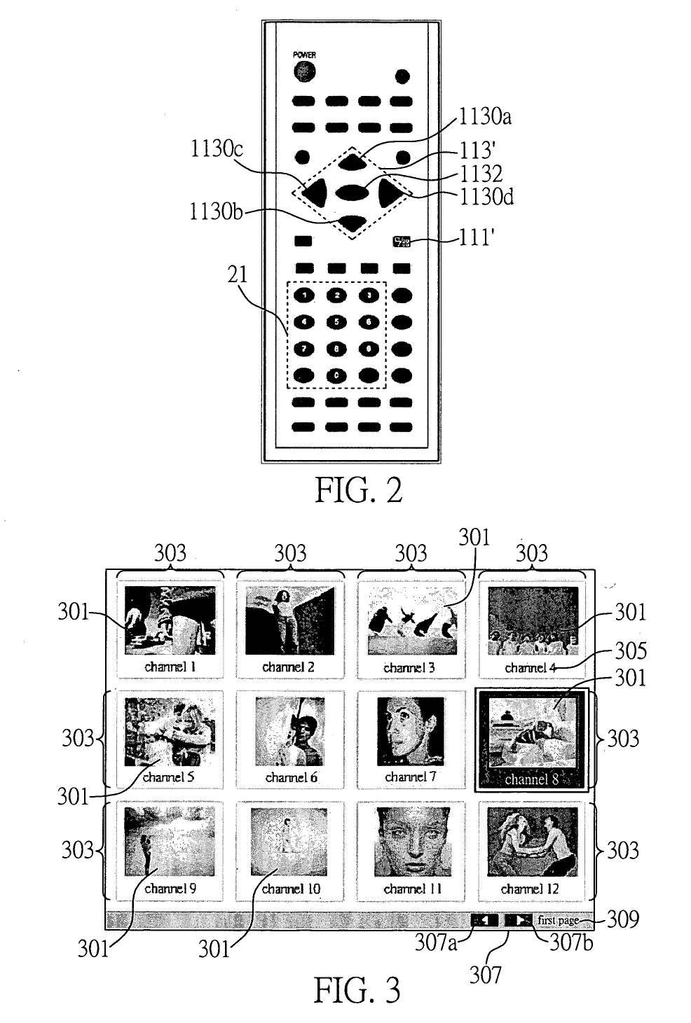

With reference to FIG. 3, an exemplary content of the display unit 20 used in conjunction with the video browsing system 1 of the present invention is shown. Channel pictures 301 are single-screen pictures reduced in scale. A plurality of channel pictures 301 can be simultaneously displayed on the display unit 20, the number of the channel pictures 301 can be suitably adjusted according to the user's interest and/or the screen size of the display unit 20. For example, based on the size of the display unit 20, the display unit 20 is divided into a plurality of position partitioning zones 303 with same size and in regular arrangement to display various channel pictures 301. Under each of the zones 303 is a text box 305 that is used to display the channel information corresponding to the particular channel picture 301. The channel information is, for example, a channel name, a channel number or a program name of the channel, wherein the selected channel picture 301 would adopt a different brightness and frame color to indicate that it is at the selected state. It can be seen from FIG. 3 that Channel 8 displayed on the display unit 20 is at the selected state. If the number of channels is too many, such that all the channel pictures cannot be displayed at once, they can be displayed in more than one pages, thus, there is a page number selecting option 307 in the picture displayed on the display unit 20. The page number selecting option 307 includes a previous page key 307a and a next page key 307b, as well as a page number display column 309 for displaying the present page number. Wherein, the user can make the display unit 20 flip pages according to the page-flipping instruction inputted via the input unit 11.

Accordingly, by virtue of the video browsing system 1 according to the present invention, browsing video in multiple pictures and selecting a picture thereof for dynamically playing can be fulfilled efficiently, so that the user can more quickly and efficiently select the desired video program, thereby saving the time for browsing through channel contents and simplifying the operating flow.

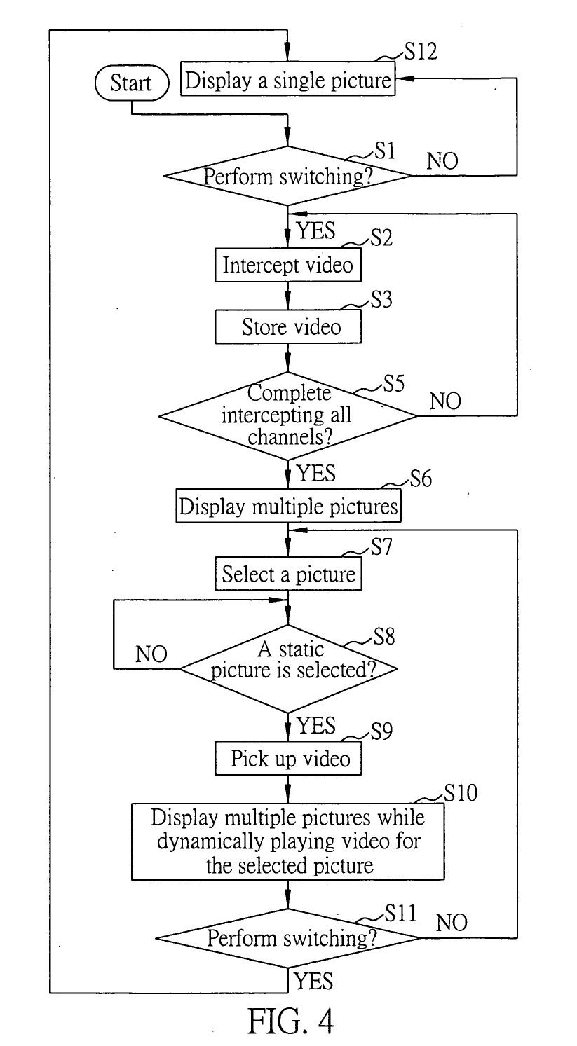

With additional reference to FIG. 4, an operation flowchart according to the video browsing method of the present invention is shown. Upon turning on a television (not illustrated herein) applying the video browsing system of the present invention, the display unit 20 generally displays certain channel information in a single-picture mode. Then step S1 as shown in FIG. 4 is proceeded, wherein the processing unit 17 judges whether it has received a picture switching instruction sent from the switch interface 111 of the input unit 11, if so, step S2 is proceed; if not, step S12 is proceeded, i.e., continue playing the certain channel program currently received by the television in single-picture display mode.

In step S2, upon the processing unit 17 receiving the switching instruction of the switch unit 111, the intercepting module 13 intercepts information of multiple channels, which include all channel programs capable of being received or the channel programs mostly often watched by the user. The channel information includes static pictures of channels at a certain time point (e.g. when the user selects the function for browsing channel programs in multi-picture mode), next step S3 is proceeded.

In step S3, the intercepting module 13 stores the static pictures (images) of the intercepted multiple channel programs in the storage unit 15 for subsequent process, wherein the static picture can be stochastically intercepted, then step S5 is proceeded.

In step S5, the intercepting module 13 judges whether all channel programs are intercepted, if so, step S6 is performed, and if not, step S2 is performed again. Since that the intercepting module 13 is continuously or intermittently receiving channel information passed from various channels, certain channel information may have been intercepted after powering on or a period of time before (e.g. ten minutes ago). Accordingly, a flag can be used to indicate that the video signal for a channel has already been intercepted, in order to prevent miss of interception of any channel information sent by the channels and avoid repetition of intercepting the already obtained channel.

In step S6, the processing unit 17 receives a plurality of static pictures representing the channel information and allows them to be displayed on the display unit 20 in the multi-picture mode for browsing and selecting by the user. The channel pictures 301 are single pictures with reduced scale. A plurality of regularly arranged pictures can be simultaneously displayed on the display unit 20, under each picture is a text box that is used to display the channel information according to the picture. If the number of channels is too many, such that all the channel pictures cannot be displayed in a single picture, they can be displayed in several pages, thus, there are page number options in the picture displayed on the display unit 20, the page number options indicate to the user the total page number of the pictures capable of being displayed and current page number, such as the display picture provided by the display unit 20 shown in FIG. 3, then step S7 is proceeded.

At step S7, the user can understand, to some degree, the program contents played in those channels by viewing the static multiple pictures provided by the display unit 20. If the user still cannot determine the specific program contents from the static pictures, he/she may select a particular channel via the select interface 113 including the set of directional keys 1130 and the confirm key 1132. The select interface 113 can be controlled by the page number selecting option 307 shown in the display picture provide by the display unit 20 so as to flip pages (i.e. inputting page-flipping instruction), thereby, the user can quickly select the program picture that interests him/her, next step S8 is proceeded.

In step S8, the processing unit 17 judges whether the select signal sent from the select interface 113 of the input unit 11 is a static picture, i.e., whether the users select a static picture from the multiple pictures displayed on the display unit 20 by the input unit 11, if so, step S9 is proceeded; if not, step S8 is continually performed to judge whether the user has selected a desired channel program.

In step S9, no matter how long it takes for the input unit 11 to select a static picture among multiple pictures displayed on the display unit 20, the processing unit 17 determines the channel corresponding to the selected static picture sent from the select interface 113, and allows the intercepting unit 13 to pick up the channel information of the channel, then step S10 is proceeded.

In step S10, the processing unit 17 replaces the static picture previously displayed on the display unit 20 with dynamic channel program intercepted by the intercepting module 13, next step S11 is performed. Wherein, the display unit 20 simultaneously displays channel information in multi-picture mode on its display page, and at the same time, dynamically plays the information of the channel corresponding to the picture selected by the user on the display zone of that picture. This step allows the user to view the program content of the selected channel in detail.

In step S11, the processing unit 17 judges whether the picture switching instruction is sent by the switch interface 111 of the input unit 11, if so, step S12 is performed, i.e., presently, the television is at the multi-picture display mode, and the multi-picture display mode is switched to the single-picture display mode according to the received switching instruction, wherein, the channel displayed is the last channel selected in step S9 before proceeding to step S10, of course, the channel displayed can be other channels according to different exemplary embodiments (e.g. the first channel being played when the television power is turned on, etc.). At the other hand, if the processing unit 17 still does not receive the picture switching instruction sent from the switch interface 111 of the input unit 11 after dynamically playing the selected channel program for a period of time in step S10, step S7 is performed again, thereby the display unit 20 returning to display channel programs in the multi-picture mode.

In another exemplary embodiment, in step S9, the processing unit 17 allows the intercepting unit 13 to pick up and dynamically play the channel information of the channel corresponding to the static picture confirmed by the confirm key 1132 of the select interface 113, thereby fulfilling dynamic and immediate playing.

By virtue of the above-described video browsing system and method, the user can use the multi-picture display mode to quickly browse a plurality of channel programs and dynamically play a program by efficiently selecting the corresponding static picture shown on the display unit, and achieves quick and repeated switching between the single-picture display mode and the multi-picture display mode, thereby saving channel selection time and simplifying the operating flow.

The above embodiments are only used to illustrate the principles of the present invention, and they should not be construed as to limit the present invention in any way. The above embodiments can be modified by those with ordinary skills in the arts without departing from the scope of the present invention as defined in the following appended claims.

What is claimed is:

1. A video browsing system applied in an electronic device having a display unit for playing channel information, the video browsing system comprising:
a processing unit;
an input unit electrically connected with the processing unit, for allowing a user to input a switching instruction of a displayed picture and a selecting instruction, and sending the switching instruction and the selecting instruction to the processing unit;
an intercepting module electrically connected with the processing unit, for intercepting a plurality of records of channel information when the switching instruction received by the processing unit from the input unit is a multi-picture display switching instruction; and
a storage unit electrically connected with the processing unit and the intercepting module, for storing the plurality of records of channel information intercepted by the intercepting module, allowing the plurality of records of channel information to be displayed by the processing unit on the display unit in a display mode of multiple pictures in at least one page,
wherein in response to receiving the selecting instruction sent from the input unit, the processing unit is configured to obtain channel information corresponding to a picture indicated by the selecting instruction and dynamically play the obtained channel information on the display unit.

2. The video browsing system of claim 1, wherein the input unit for allowing the user to input the switching instruction of the displayed picture is performed through a switch interface provided thereon.

3. The video browsing system of claim 2, wherein the input unit is one of a remote controller and a set of keys provided on the electronic device.

4. The video browsing system of claim 1, wherein the switching instruction sent from the input unit further comprises a single-picture display instruction, allowing the processing unit to display the channel information as a single picture on the display unit upon receiving the single-picture display instruction from the input unit.

5. The video browsing system of claim 1, wherein the input unit for allowing the user to input the selecting instruction is performed through a select interface provided thereon.

6. The video browsing system of claim 5, wherein the input unit is one of a remote controller and a set of keys provided on the electronic device.

7. The video browsing system of claim 1, wherein the channel information obtained by the processing unit based on the picture indicated by the selecting instruction is picked up by the intercepting module after receiving the selecting instruction.

8. The video browsing system of claim 1, wherein the multiple pictures are static pictures, which are static pictures of the channel information at a predetermined time point intercepted by the intercepting module and stored in the storage unit.

9. The video browsing system of claim 8, wherein the storage unit is further configured to update the storage of static pictures according to the static pictures of the channel information intercepted by the intercepting unit at the predetermined time point.

10. The video browsing system of claim 1, wherein each of the multiple pictures includes channel information corresponding to each of them.

11. The video browsing system of claim 1, wherein the processing unit is further configured to allow the display unit to page by page display pictures corresponding to channel information of multiple channels on corresponding display pages according to the plurality of records of channel information stored in the storage unit, and allow the display unit to flip pages according to a page-flipping instruction received by the input unit.

12. A video browsing method applied in an electronic device having a display unit and an input unit for playing channel information, comprising the steps of:
having the electronic device intercept and store a plurality of records of channel information upon determining that a switching instruction is received by the input unit and comprises a multi-picture display switching instruction;
reading the stored plurality of records of channel information, and displaying the channel information on the display unit in a display mode of multiple pictures in at least one page for browsing; and
upon determining that the input unit receives a selecting instruction of desired channel information, having the electronic device obtain channel information corresponding to a picture indicated by the selecting instruction and dynamically play the obtained channel information.

13. The video browsing method of claim 12, wherein the channel information obtained by the electronic device based on the picture indicated by the selecting instruction is picked up after receiving the selecting instruction.

14. The video browsing method of claim 12, wherein the multiple pictures obtained by reading the stored plurality of records of channel information and displayed on the display unit in the at least one page are static pictures.

15. The video browsing method of claim 14, wherein the static pictures are updated at a predetermined time point according to the intercepted channel information.

16. The video browsing method of claim 12, wherein each of the multiple pictures includes channel information corresponding to each of them.

17. The video browsing method of claim 12, wherein the electronic device is configured to allow the display unit to page by page display pictures corresponding to channel information of multiple channels on corresponding display pages according to the stored plurality of records of channel information, and allow the display unit to flip pages according to a page-flipping instruction received by the input unit.

18. The video browsing method of claim 12, wherein the input unit is one of a remote controller and a set of keys provided on the electronic device.

19. The video browsing method of claim 12, wherein the switching instruction received by the input unit further comprises a single-picture display instruction, allowing the electronic device to display the channel information as a single picture on the display unit upon receiving the single-picture display instruction sent from the input unit.
